(19) United States
(12) Patent Application Publication
(10) Pub. No.: US 2014/0002387 A1
(43) Pub. Date: Jan. 2, 2014

(54) ELECTRONIC APPARATUS AND CONTROL METHOD

(71) Applicant: KABUSHIKI KAISHA TOSHIBA, Tokyo (JP)

(72) Inventor: Rumiko Hashiba, Kawasaki-shi (JP)

(73) Assignee: KABUSHIKI KAISHA TOSHIBA, Tokyo (JP)

(21) Appl. No.: 13/789,007

(22) Filed: Mar. 7, 2013

(30) Foreign Application Priority Data
Jun. 29, 2012 (JP) 2012-148014

(51) Int. Cl. G06F 3/041

(52) U.S. Cl. CPC G06F 3/041
USPC 345/173

(57) ABSTRACT

An electronic apparatus includes an input device, a processor, and a display processor. The input device is configured to input a touch manipulation which is executable on a display. The processor is configured to determine a first area for displaying a first image corresponding to a first layer and a second area for displaying a second image corresponding to a second layer based on the touch manipulation. The display processor is configured to simultaneously display the first image in the first area and the second image in the second area

### CROSS REFERENCE TO RELATED APPLICATION(S)

This application is based upon and claims the benefit of priority from Japanese Patent Application No.2012-148014 filed on Jun. 29, 2012, the entire contents of which are incorporated herein by reference.

### FIELD

Embodiments described herein relate generally to an electronic apparatus in which a menu or objects are manipulated in the form of a touch manipulation and a control method.

### BRIEF DESCRIPTION OF THE DRAWINGS

FIG. 1 schematically shows an appearance of an electronic apparatus according to embodiments;

FIG. 2 is a block diagram showing an example hardware configuration of the electronic apparatus according to the embodiments;

FIGS. 3A and 3B illustrate a typical display and manipulation procedure according to the embodiments;

FIG. 4 is a block diagram showing a functional configuration according to the embodiments;

FIGS. 5A and 5B illustrate a folder display and manipulation procedure according to an example 1;

FIGS. 6A and 6B illustrate a list display and manipulation procedure according to an example 2;

FIGS. 7A and 7B illustrate a display and manipulation procedure of images having a hierarchy structure according to an example 3;

FIGS. 8A to 8C illustrate a display and manipulation procedure of text data having a hierarchy structure according to an example 4;

FIGS. 9A to 9C illustrate a display and manipulation procedure of text data having a hierarchy structure according to an example 5;

FIGS. 10A and 10B illustrate a display and manipulation procedure of text data having a hierarchy structure according to an example 6; and

FIG. 11 is a flowchart of a process which is executed by the electronic apparatus according to the embodiments.

### DETAILED DESCRIPTION

According to one embodiment, an electronic apparatus includes an input device, a processor, and a display processor. The input device is configured to input a touch manipulation which is executable on a display. The processor is configured to determine a first area for displaying a first image corresponding to a first layer and a second area for displaying a second image corresponding to a second layer based on the touch manipulation. The display processor is configured to simultaneously display the first image in the first area and the second image in the second area.

Various embodiments will be described hereinafter with reference to the accompanying drawings.

Particularly, an electronic apparatus and a control method according to embodiments will be described with reference to the accompanying drawings. The electronic apparatus 100 according to the embodiments is, for example, a PDA (personal digital assistance), a mobile phone, or the like, functions as a signal processing apparatus relating to display processing, and is used with being gripped by a user or being attached to something.

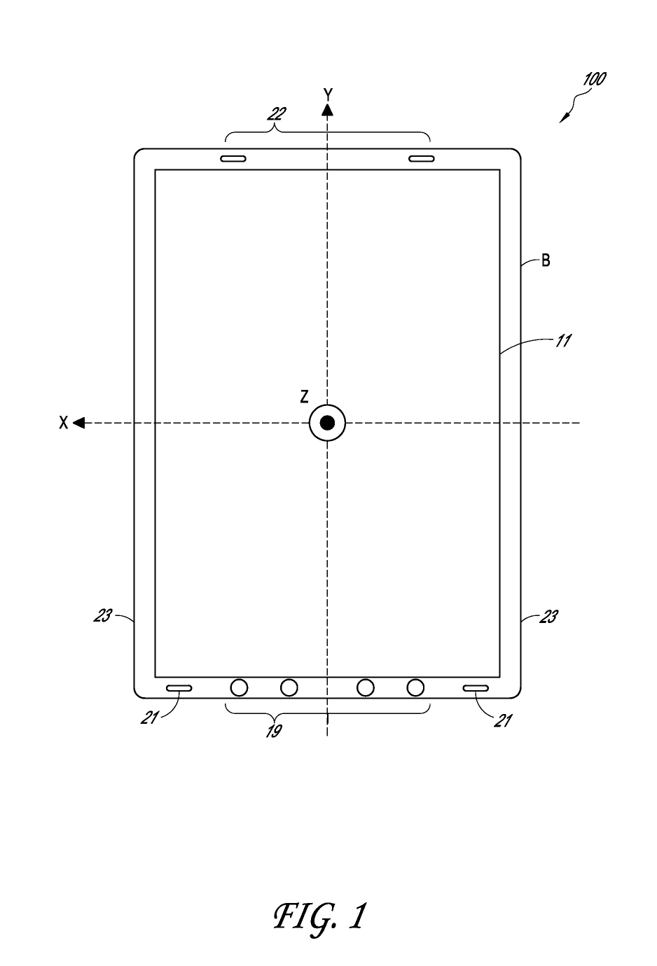

FIG. 1 schematically shows an appearance of the electronic apparatus 100 according to the embodiments. The electronic apparatus 100 is information processing apparatus having a display screen and, more specifically, is a slate terminal (tablet terminal), an e-book reader, a digital photoframe, or the like. In FIG. 1, the positive directions of the X axis, Y axis, and the Z axis are indicated by arrows (the positive direction of the Z axis is the direction toward the front side of the sheet of FIG. 1).

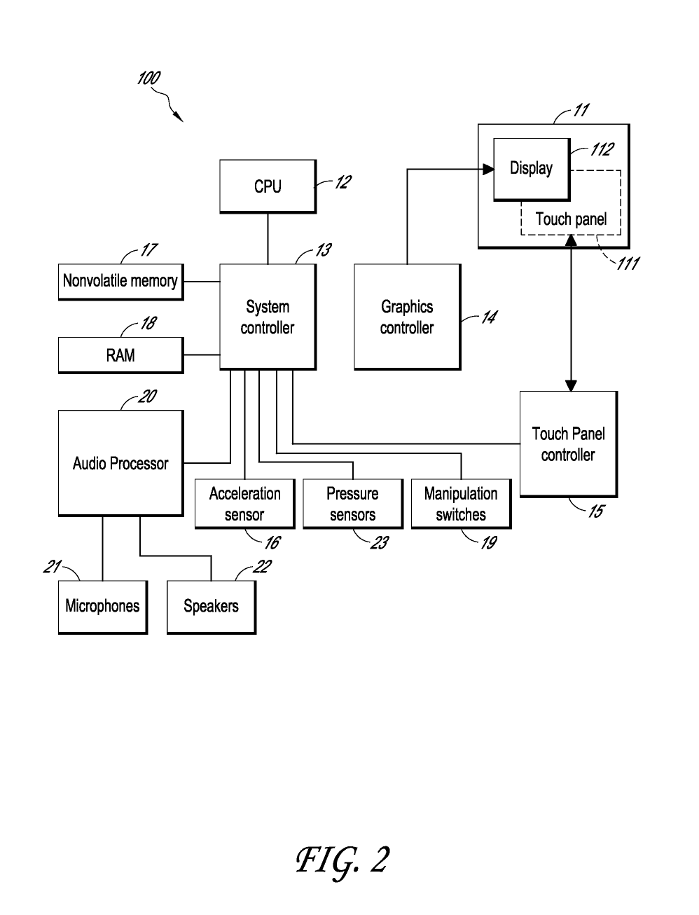

The electronic apparatus 100 has a thin, box-shaped body B. A display module 11 is provided on the front surface of the body B. The display module 11 is equipped with a touch panel 111 (see FIG. 2) configured to detect a user's touch position on the display screen. The bottom portion of the front surface of the body B is provided with manipulation switches 19 or the like configured to allow a user to perform various manipulations and microphones 21 configured to pick up a user's voice. The top portion of the front surface of the body B is provided with speakers 22 configured to sound output. Pressure sensors 23 configured to detect a pressure that is exerted by the user who is gripping the body B are provided on edges of the body B. Although FIG. 1 shows the example where the pressure sensors 23 are provided on the left and right edges in the X direction, the pressure sensors 23 may be provided on the upper and lower edges in the Y direction.

FIG. 2 is a block diagram showing an example hardware configuration of the electronic apparatus 100 according to the embodiments. As shown in FIG. 2, the electronic apparatus 100 is equipped with, in addition to the above-described components, a CPU 12, a system controller 13, a graphics controller 14, a touch panel controller 15, an acceleration sensor 16, a nonvolatile memory 17, a RAM 18, an audio processor 20, etc.

The display module 11 includes the touch panel 111 and a display 112 such as an LCD (liquid crystal display) or an organic EL (electroluminescence) display. For example, the touch panel 111 includes a coordinates detecting device that is disposed on the display screen of the display 112 and that is configured to detect coordinates on this surface. The touch panel 111 can detect a position (touch position) on the display screen where the touch panel 111 has been touched by, for example, a finger of the user who is gripping the body B. This function of the touch panel 111 allows the display 112 to serve as what is called a touch screen.

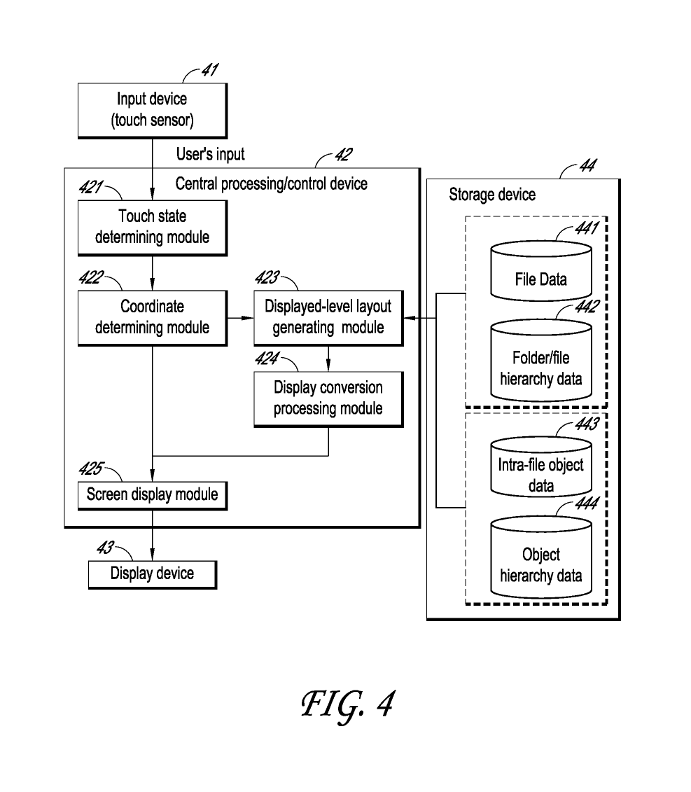

The CPU 12 is a central processor configured to control operations of the electronic apparatus 100, and controls individual components of the electronic apparatus 100 via the system controller 13. The CPU 12 realizes individual functional modules (described later with reference to FIG. 4) by running an operating system and various application programs that are loaded into the RAM 18 from the nonvolatile memory 17. As a main memory of the electronic apparatus 100, the RAM 18 provides a work area to be used by the CPU 12 when the CPU 12 runs a program(s).

The system controller 13 incorporates a memory controller configured to access-control the nonvolatile memory 17 and the RAM 18. The system controller 13 also has a function of executing a communication with the graphics controller 14.

The graphics controller 14 is a display controller configured to control the display 112 which is used as a display monitor of the electronic apparatus 100. The touch panel controller 15 controls the touch panel 111 to thereby acquire, from the touch panel 111, coordinate data that indicates a touch position on the display screen of the display 112.

For example, the acceleration sensor 16 is a 3-axis acceleration sensor configured to detect acceleration in three axis directions (X, Y, and Z directions) shown in FIG. 1, a 6-axis acceleration sensor configured to detect acceleration in rotational directions around the three axes as well as acceleration in the three axis directions, or the like. The acceleration sensor 16 detects a direction and a magnitude of acceleration of the electronic apparatus 100 that is caused externally and outputs the detection results to the CPU 12. More specifically, the acceleration sensor 16 outputs, to the CPU 12, an acceleration detection signal (inclination information) including information of acceleration-detected axes, a direction of the acceleration (in the case of rotation, a rotation angle), and a magnitude of the acceleration. A gyro sensor configured to detect an angular velocity (rotation angle) may be integrated with the acceleration sensor 16.

The audio processor 20 performs audio processing such as digital conversion, noise elimination, and echo cancellation on audio signals supplied from the microphones 21, and outputs a resulting signal to the CPU 12. Also, the audio processor 20 performs audio processing such as voice synthesis under the control of the CPU 1, and supplies a generated audio signal to the speakers 22 to make a voice notification through the speakers 22.

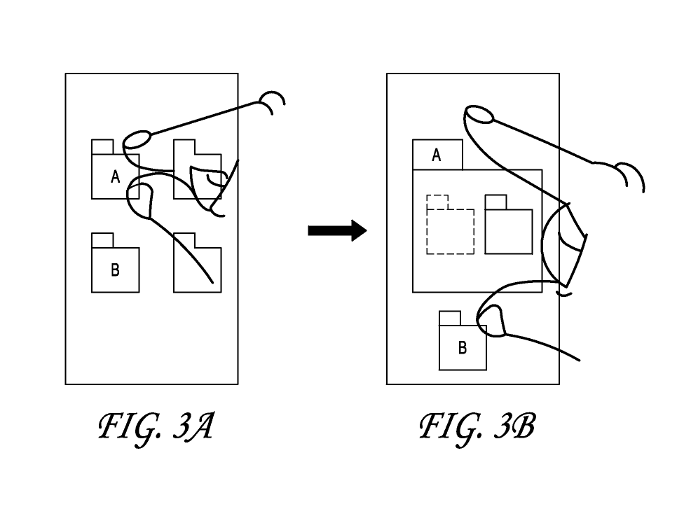

FIGS. 3A and 3B illustrate a typical display and manipulation procedure according to the embodiments.

In the embodiments, it is assumed that the electronic apparatus 100 is equipped with a touch sensor or a pointer input device such as a mouse, and that user manipulation information is acquired from an input device 41 (described later; the electronic apparatus 100 is equipped with the touch sensor in the above case where the touch panel 111 is provided). It is also assumed that the user manipulation information acquired from the input device 41 include, for example, information of two points. A touch state determining module 421 (described later) determines a kind of manipulation such as pinch-out or drag, based on a variation of a distance between the two points.

FIG. 3A schematically illustrates a state where the user is about to pinch out a folder A on the screen of the display 112 of the display module 11 on which folders A, B, C, etc. are displayed. If the folder A is pinched out, as shown in FIG. 3B the folder A is enlarged and folder B and the like are pushed out to peripheral positions or the outside of the screen, and a lower level than the folder A (alternatively, contents of that level, details of that level, or the like) is displayed. In the example of FIG. 3B, two subfolders of the folder A are displayed (which are indicated by a solid line and a broken line, respectively).

As for a drag manipulation, the pinched-out region is enlarged if an end portion of the pinched-out region is dragged additionally with a single touch. The enlarged region is calculated based on the coordinates of a rectangle that circumscribes the original region (the region before enlarged) and drag destination coordinates.

FIG. 4 is a block diagram showing a functional configuration, relating to display processing, according to the embodiments. The functional configuration includes four blocks, that is, an input device 41, a central processing/control device 42, a display device 43, and a storage device 44. The central processing/control device 42 includes five blocks, that is, the touch state determining module 421, a coordinate determining module 422, a displayed-level layout generating module 423, a display conversion processing module 424, and a screen display module 425. The storage device 44 includes four kinds of data, that is, file data 441, folder/file hierarchy data 442, intra-file object data 443, and object hierarchy data 444.

The input device 41 includes the touch panel 111 of the display module 11 and the touch panel controller 15 of the electronic apparatus 100. The display device 43 corresponds to the display 112 of the display module 11. The storage device 44 corresponds to the nonvolatile memory 17.

On the other hand, the central processing/control device 42 may be implemented by the CPU 12, the system controller 13, and the RAM 18. The screen display module 425 of the central processing/control device 42 mainly corresponds to the graphics controller 14. The other blocks of the central processing/control device 42, that is, the touch state determining module 421, the coordinate determining module 422, the displayed-level layout generating module 423, and the display conversion processing module 424 may be implemented by the CPU 12 and the system controller 13.

With the above configuration, to display objects having a hierarchy relationship relating to folders or files in the form of icons, thumbnails, or the like, the displayed-level layout generating module 423 acquires information from the file data 441 and the folder/file hierarchy data 442.

After detection of multi-touch, the central processing/control device 42 operates dominantly to calculate distances from the coordinates of two pinch-out start points to coordinates of touched points after the pinch-out manipulation (coordinates of destination points) and determines an attribute of an object that was displayed at the center of the two pinch-out start points. If the determined attribute is a folder or its equivalent, the display conversion processing module 424 acquires a group of data that are in a lower level than the folder concerned and displays the folder concerned in an enlarged manner at a size corresponding to the pinch-out distances. Folders or icons of the group of data, which are in the lower level than the folder concerned, are displayed in the enlargement-displayed region. The folder concerned includes files, folders or icons in the lower level.

This display may be implemented by having the display conversion processing module 424 pass screen information to the screen display module 425. Data constituting the hierarchy structure are enlargement-displayed sequentially by repeating this manipulation for each level. If it is determined based on movement distances after the detection of the multi-touch that a user's manipulation corresponds to pinch-in, the display conversion processing module 424 deletes the current display of the folder concerned and displays a group of data that are in a level higher than the folder concerned.

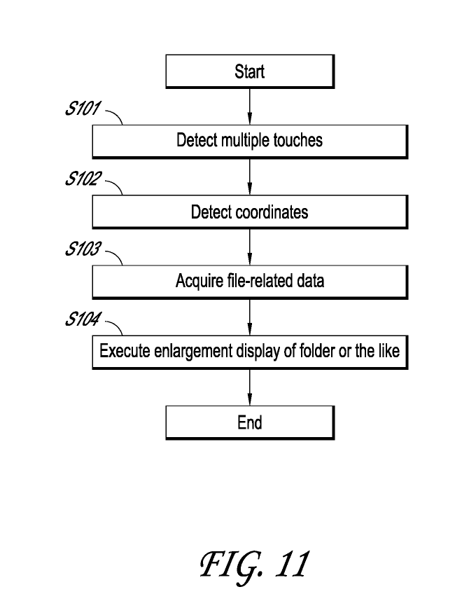

FIG. 11 shows a process flowchart as a summary of the above operation.

Step S101: The touch state determining module 421 detects multi-touch.

Step S102: The coordinate determining module 422 detects coordinates.

Step S103: The displayed-level layout generating module 423 acquires information from the file data 441 and the folder/file hierarchy data 442.

Step S104: The display conversion processing module 424 performs folder enlargement display, for example.

### EXAMPLE 1

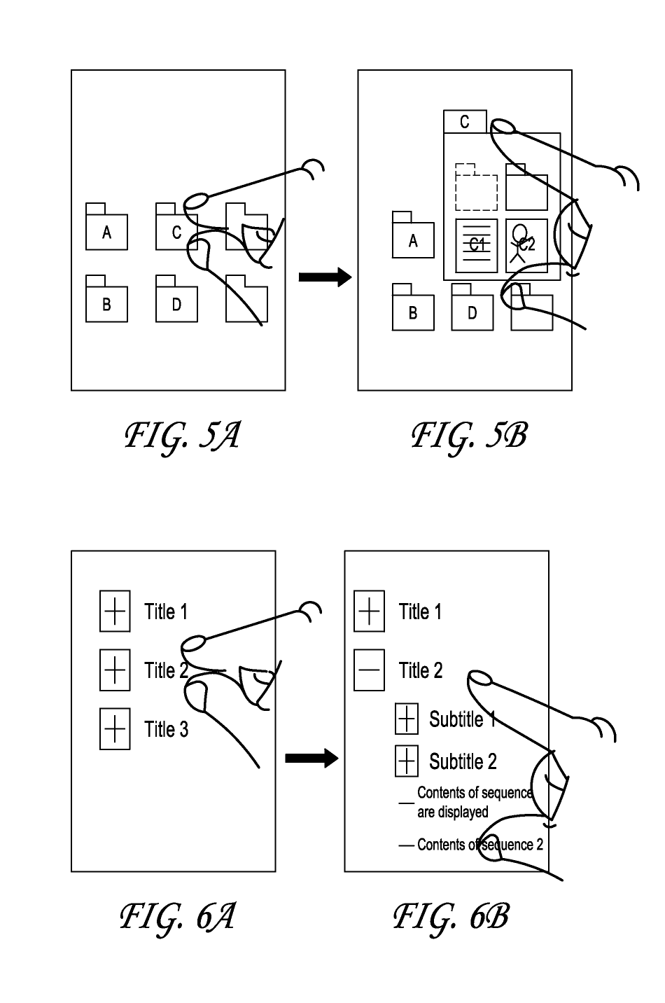

FIGS. 5A and 5B illustrate a folder display and manipulation procedure according to an example 1.

FIG. 5A schematically illustrates a state where a user is about to pinch out a folder C on the screen of the display 112 of the display module 11 on which folders A, B, C, D, etc. are displayed. If the folder C is pinched out, as shown in FIG. 5B the folder C is enlarged and information in a lower level than the folder C (alternatively, contents in that level, details in that level, or the like) are displayed. In the example of FIG. 5B, not only are two subfolders of the folder C displayed (which are indicated by a solid line and a broken line, respectively) but also a text file C1 and an image file C2 are displayed in the form of icons.

### EXAMPLE 2

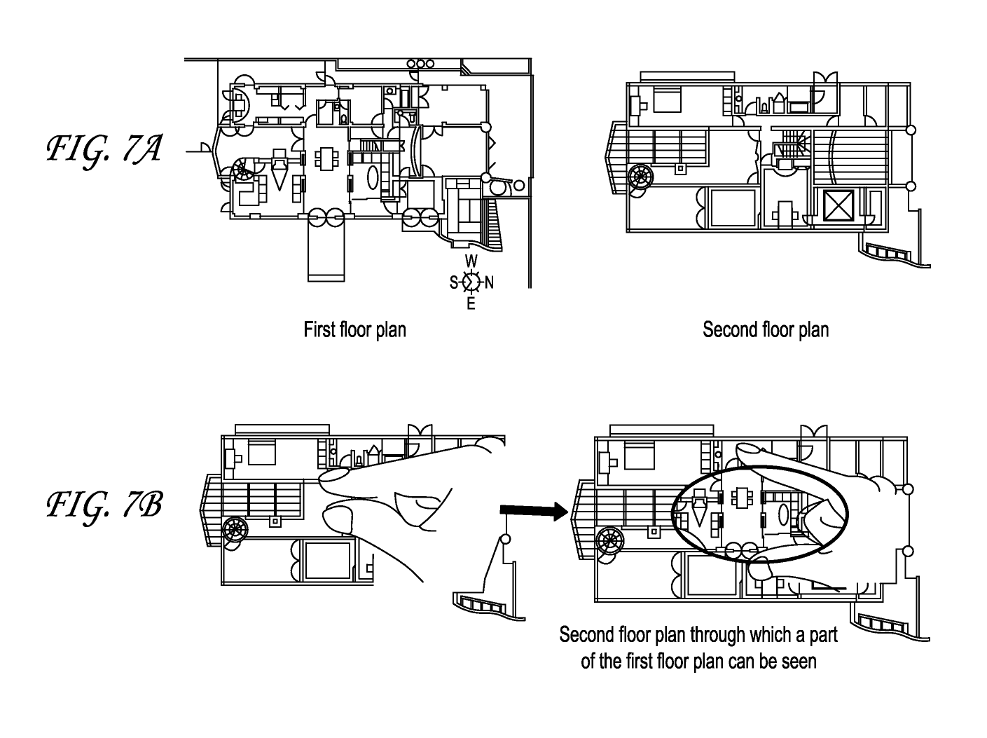

FIGS. 6A and 6B illustrate a list display and manipulation procedure according to an example 2.

If objects having a hierarchical relationship relating to folders or files are reduction-displayed in the form of a list, the displayed-level layout generating module 423 acquires data that are in a lower level than each file (and/or each folder) being displayed. When a user's pinch-out manipulation is detected, distances from coordinates of two pinch-out start points to coordinates of touch points after the pinch-out manipulation (coordinates of destination points) are calculated and data (lower-level data) in a level lower than an object that was displayed at the center of the two pinch-out start points are determined. The display conversion processing module 424 displays objects in the lower level than the pinched-out object are displayed in the list form at a size corresponding to the pinch-out distances based on the thus-determined data. Objects having the hierarchical relationship are enlargement-displayed sequentially by repeating this manipulation for each level. If it is determined that movement distances of the multi-touch after the detection of the multi-touch correspond to pinch-in, the display conversion processing module 424 deletes currently-displayed object(s) in the list and displays an object(s) in a higher level than the deleted object(s).

In this example, as shown in FIG. 6A, titles of three texts, that is, title 1 to title 3, are displayed. If the title 2 is pinched out, as shown in FIG. 6B a lower structure of the title 2 is opened. In this example, the title 2 has two subtitles. If the second subtitle, that is, subtitle 2, is pinched out further, its contents which are a message text “The contents of text 1 are being displayed” and the like is displayed.

### EXAMPLE 3

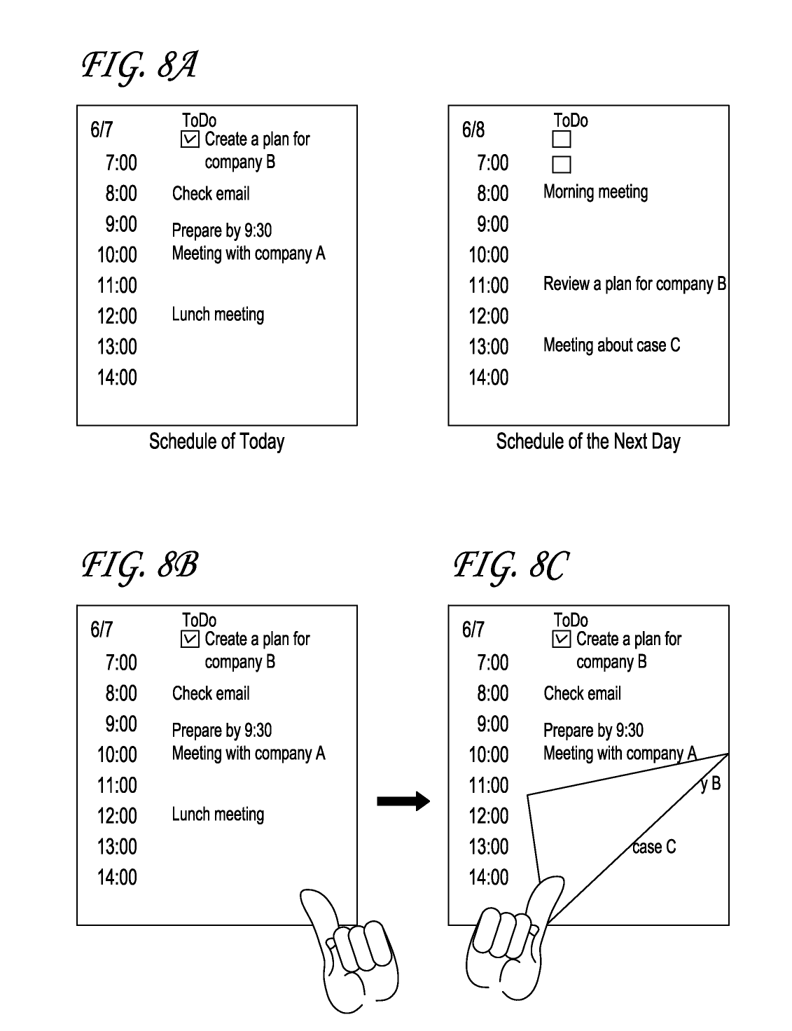

FIGS. 7A and 7B illustrate a display and manipulation procedure of images having a hierarchy structure according to an example 3.

In the case where files having a hierarchical relationship relating to locations are displayed, a file (s) that are in lower levels than a file being currently displayed are displayed in lower layers in a superimposed manner. The displayed-level layout generating module 423 defines, as a layout transmission region, an elliptical region that has its center at an intermediate point between two pinch-out start points (it is assumed that the center of the ellipse is an intersection between long and short axes of the ellipse) and has touched points after pinch-out on an outer periphery of the ellipse. An object(s) that were displayed in the pinched-out region are displayed outside the layout transmission region. A layout after the pinch-out is calculated based on coordinates of objects before the pinch-out and a difference between coordinates of the touched points after the pinch-out.

FIG. 7A shows plans of respective floors of a certain building. If a certain portion of the second floor plan is pinched out, as shown in FIG. 7B a substantially elliptical transmission region is opened, and a corresponding portion of the first floor plan is displayed there.

### EXAMPLE 4

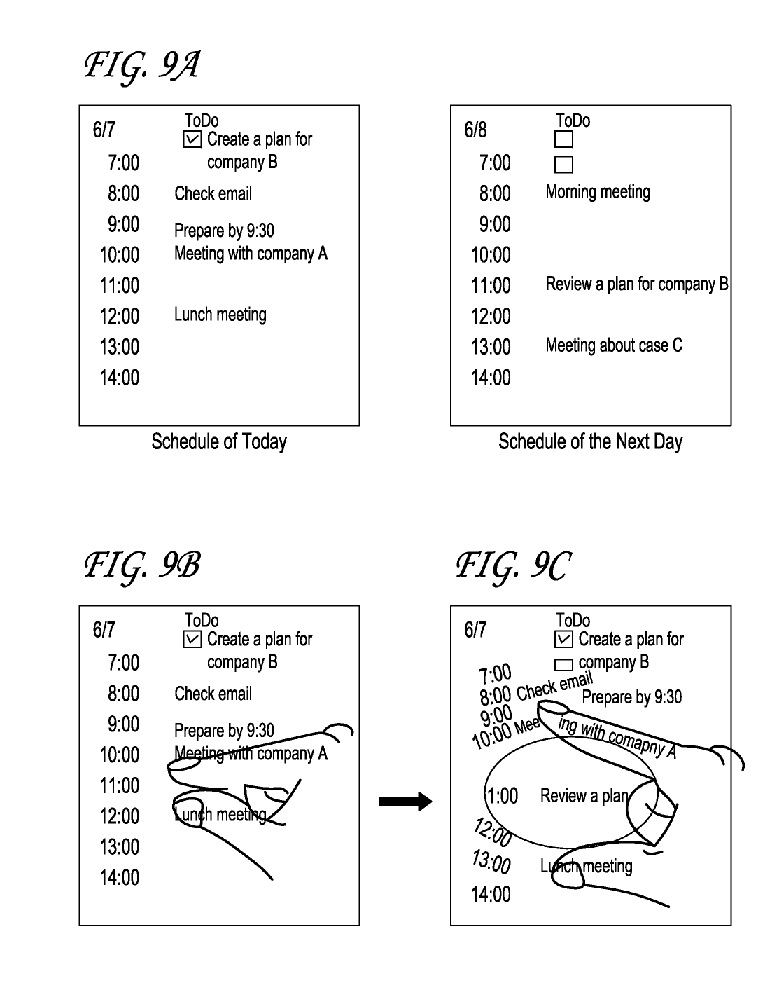

FIGS. 8A to 8C illustrate a display and manipulation procedure of text data having a hierarchy structure according to an example 4.

In the case where files having an attribute such as a time series (for example, date and/or time), a file corresponding to a following time is displayed in superimposed manner in a lower layer than a file corresponding to a preceding time. If a single touch is detected near the bottom-right corner of the screen, the displayed-level layout generating module 423 defines a layout transmission region based on a movement amount of the touch position. A region, corresponding to the layout transmission region, in the lower layer is displayed during a period in which the single touch is maintained. Thereby, it makes possible to see a part of a schedule of the next day.

In the example 4, as shown in FIG. 8B, a schedule of today is being displayed. If a turn-over (slide) manipulation is performed on the bottom-right portion, as shown in FIG. 8C a layout transmission region is set, and a part of a schedule of the next day appears there as a lower layer. The electronic apparatus 100 may be configured so that the above display which is caused by the turn-over manipulation may also be caused by a mouse drag manipulation.

### EXAMPLE 5

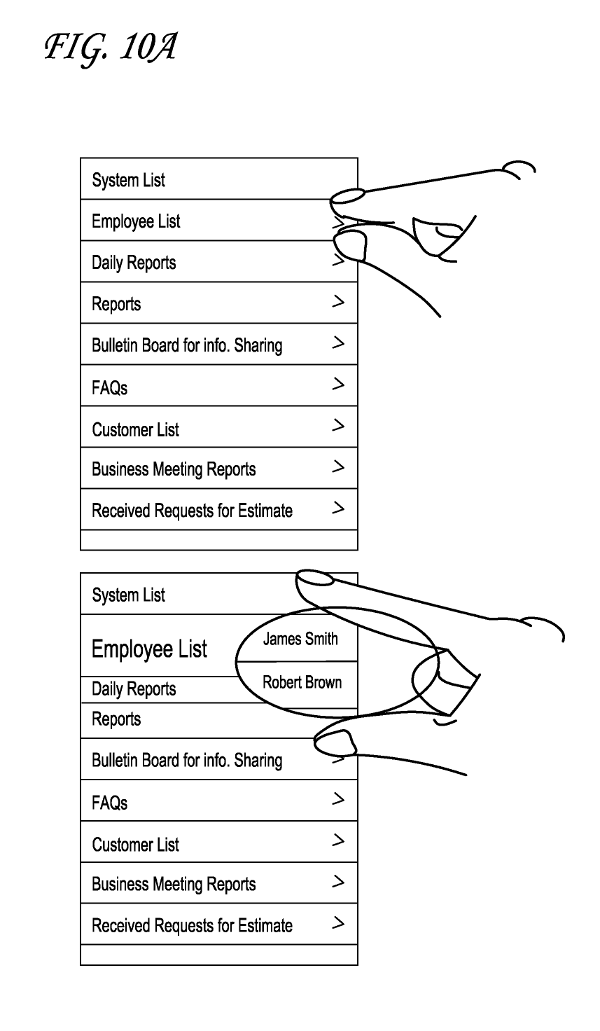

FIGS. 9A to 9C illustrate a display and manipulation procedure of text data having a hierarchy structure according to an example 5.

In the case where files having such an attribute as a time series (for example, date and/or time), a file corresponding to a following time is displayed in superimposed manner in a lower layer than a file corresponding to a preceding time. The displayed-level layout generating module 423 defines, as a layout transmission region, an elliptical region that has its center at an intermediate point between two pinch-out start points (it is assumed that the center of the ellipse is an intersection between long and short axes of the ellipse) and has touched points after pinch-out on an outer periphery of the ellipse. An object(s) that were displayed in the pinched-out region are displayed outside the layout transmission region. A layout after the pinch-out is calculated based on coordinates of objects before the pinch-out and a difference between coordinates of the touched points after the pinch-out.

In the example 5, as shown in FIG. 9B, a schedule of today is being displayed. If the item of 11:00 is pinched out, as shown in FIG. 9B a layout transmission region is set, and a part of a schedule of the next day appears there as a lower level. In this example, for “Create a plan for company B” which is a checked item in the To Do list, a portion of “Review a plan for company B” in the schedule of the next day appears to thereby enable a user to recognize the relationship therebetween.

User menu settings, etc. may be designed so that the above display, which is caused by the pinch-out manipulation, is caused using a mouse. For example, the user menu settings, etc. may be designed so that if a user continues to click on the center of a target portion for a while and then clicks on two points located over and under the center, a substantially elliptical window delimited by the two points is opened. Alternatively, the user menu settings, etc. may be designed so that if a user continues to click on the center of a target portion for a while and then clicks on two points located on diagonal points with respect to the center such as the top-left and the bottom-right of the center, a rectangular window having the diagonal points as vertexes facing each other is opened. These measures also apply to other examples in a similar manner.

The electronic apparatus 100 may be configured so that a portion of a page containing meeting minutes appears as a lower level in response to a certain manipulation.

When a schedule item is pinched out, detailed information of the item is displayed. However, such detailed information is not limited to meeting minutes. For example, in the case where the item is a lunch meeting, contents of a meeting notice of Microsoft Outlook (registered trademark) such as a place of the lunch meeting, persons who attend the lunch meeting, and a subject of the lunch meeting may be displayed.

In the case where a plan is reviewed, the electronic apparatus 100 may be configured so that a link to a Gantt chart of a project and a link to a file management system storing the plan are also displayed in a selectable manner (by a file open manipulation or the like).

A related schedule that is correlated with the schedule item may be displayed as lower-level information. Information other than the detailed information of the schedule item itself, such as another schedule item correlated with that schedule item by a tag or a link, may be recognized as a part of a lower level and displayed.

### EXAMPLE 6

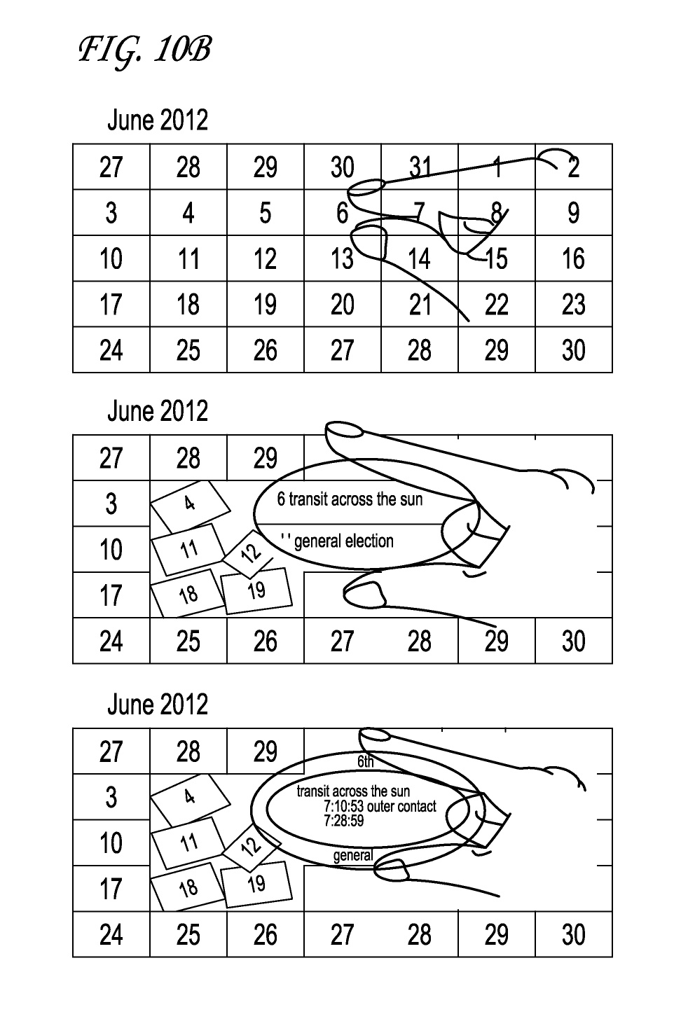

FIGS. 10A and 10B illustrate display and manipulation procedures of text data having a hierarchy structure according to an example 6.

### (1) In Case of List (FIG. 10A)

In the case where items (objects) are arranged in a vertical or horizontal direction and each item has accompanying information (e.g., detailed items), when a peripheral portion of an item is pinched out, the region of the item is enlargement-displayed (other items around the enlarged item are reduced according to their distances from the enlarged item), and the accompanying information (e.g., detailed items) of the enlarged item is displayed.

In this example, an “employee list” is selected from a system list and pinched out, whereby the names of two persons (Mr. James Smith and Mr. Robert Brown) are displayed.

### (2) In Case of Calendar (FIG. 10B)

In the case where a calendar (one month, one week, or the like) is displayed, if a peripheral portion of a particular date is pinched out, lower-level information (e.g., a schedule of that date) of the item of that date is enlargement-displayed (rectangles representing dates around the enlarged date are reduced). Furthermore, if a peripheral portion of a schedule item is pinched out, detailed information of that item is displayed in the enlarged region.

As shown in the middle part of FIG. 10B, an item “transit across the sun” and an item “general election” which will occur on or is scheduled for June 6th are displayed. If the former item is pinched out, as shown in the bottom part of FIG. 10B a user can be informed of times of occurrences of first contact (the start of an outer eclipse of the sun), second contact (the start of an inner eclipse of the sun), etc. (a time of occurrence (around 10:30 not shown) of minimum elongation may be added (not shown)). In the case of “general election,” the user can be informed of, for example, a program, etc. of a live broadcast which will start at 19:00 (not shown).

### (3) In Case of Calendar (Modified Example of the Item (2); Not Shown)

In the case where a calendar (one month, one week, or the like) is displayed, if a peripheral portion of a particular date is pinched out, the rectangle representing the particular date is enlargement-displayed (rectangles representing dates around the enlarged date are translated and reduced) and information such as a schedule of the enlarged date is displayed there. Furthermore, if a peripheral portion of a schedule item is pinched out, detailed information of that item is displayed in the enlarged rectangle.

As described above, as for the manipulation of a terminal having a touch screen, the embodiments provide the function of improving the performance of browsing of low-level information without screen switching by manipulating an object displayed on the screen (e.g. a pinch or slide manipulation).

The embodiments make it possible to see lower-level information while keeping higher-level information displayed. This provides an advantage that even in a terminal whose screen is small in display area information in different levels can be seen simultaneously and compared with each other without losing information indicating a relationship between levels.

The invention is not limited to the above embodiments, and various modifications are possible without departing from the spirit and scope of the invention.

Various inventive concepts may be conceived by properly combining plural constituent elements described in each embodiment. For example, several ones of the constituent elements of each embodiment may be omitted. Furthermore, constituent elements of different embodiments may be combined appropriately.

What is claimed is:

1. An electronic apparatus comprising:
an input device configured to input a touch manipulation which is executable on a display;
a processor configured to determine a first area for displaying a first image corresponding to a first layer and a second area for displaying a second image corresponding to a second layer based on the touch manipulation; and
a display processor configured to simultaneously display the first image in the first area and the second image in the second area.

2. The apparatus of claim 1, wherein the touch manipulation comprises at least one of a pinch manipulation, a slide manipulation, and a drag manipulation.

3. The apparatus of claim 1, wherein the processor is configured to determine the first area and the second area based on a contact position of the touch manipulation.

4. The apparatus of claim 1, wherein if a contact position of the touch manipulation corresponds to a displayed area of a menu or an object in the first layer, the display processor is configured to display the second image which is related with the menu or the object.

5. The apparatus of claim 1, further comprising:
the display configured to simultaneously display the first image in the first area and the second image in the second area.

6. A control method of an electronic apparatus comprising an input device configured to input a touch manipulation which is executable on a display, the method comprising:
inputting the touch manipulation which is executable on a display;
determining a first area for displaying a first image corresponding to a first layer and a second area for displaying a second image corresponding to a second layer based on the touch manipulation; and
simultaneously displaying the first image in the first area and the second image in the second area.

7. A computer-readable storage medium storing a program that causes a processor to execute a process for controlling an electronic apparatus comprising an input device configured to input a touch manipulation which is executable on a display, the process comprising:
inputting the touch manipulation which is executable on a display;
determining a first area for displaying a first image corresponding to a first layer and a second area for displaying a second image corresponding to a second layer based on the touch manipulation; and
simultaneously displaying the first image in the first area and the second image in the second area.
